(19) United States
(12) Patent Application Publication
(10) Pub. No.: US 2014/0175758 A1
(43) Pub. Date: Jun. 26, 2014

(54) SHAFT SEAL WITH RETENTION FEATURES

(71) Applicant: Parker-Hannifin Corporation, Cleveland, OH (US)

(72) Inventor: Berndt L. Luchs, Rustburg, VA (US)

(21) Appl. No.: 14/104,083

(22) Filed: Dec. 12, 2013

Related U.S. Application Data
(60) Provisional application No. 61/740,786, filed on Dec. 21, 2012.

(51) Int. Cl. F16J 15/32

(52) U.S. Cl. CPC F16J 15/3204
USPC 277/572

(57) ABSTRACT

A shaft seal assembly includes a seal component with a bore retention feature, and a housing structure. The seal component includes a hook retention feature including a hook element that hooks around a ridge of the housing structure that partially defines the bore. The hook retention feature may include a first surface, a second surface, and a third surface that define a recess that receives the portion of the housing structure. The third surface may be a bottom surface of a hook that extends around the received portion of the housing structure.

### FIELD OF THE INVENTION

The present invention is directed to a seal for a shaft seal assembly configured for use in conjunction with bore housing seal assemblies, and particularly to a shaft seal with enhanced retention features for retaining the seal material to a bore housing.

### BACKGROUND OF THE INVENTION

Various shaft sealing applications are provided in extreme environments of high pressure, temperature extremes, rotational and other exertion forces, and the like. Examples of such environments include automotive and light truck automatic transmission and engine systems, in which shaft seals are used for front crank assemblies and covers, cam-lock structures, and other applications.

FIG. 1 is a schematic diagram depicting a perspective view of a portion of a conventional shaft seal assembly 10. The shaft seal assembly 10 may extend circumferentially substantially to form a ring structure. The shaft seal assembly includes a housing structure 12 against which is inserted a seal component 14. The housing structure 12 typically is a rigid or semi-rigid material, such as a rigid or semi-rigid molded plastic or metal material. For applications of the type referenced above, nylon-based plastics materials are now common. The housing structure includes a bore 16 that constitutes a recessed area or surface in which the seal rests. In the example of FIG. 1, the bore 16 is defined partially by a ridge 18 that provides a positive stop for the seal within the housing structure.

As referenced above, the shaft seal assembly 10 further includes the seal component 14. The seal component 14 of FIG. 1 includes an elastomeric element 20 formed about a substrate 22. The elastomeric element generally provides flexibility to the seal so the seal may be compressed and energized to form a tight seal within the bore of the housing structure. The substrate 22 is formed of a more rigid material, such as a rigid or semi-rigid plastic or metal (steel for example) that acts as a stiffener element for controlling in part the degree of compressibility of the surrounding elastomeric element 20.

As seen in FIG. 1, in the conventional configuration the seal component 14 has an outer diameter 24 onto which there are formed a plurality of rib structures 26. The seal component 14 is held in place within bore 16 by frictional forces of the rib structures 26 against the surface of the bore 16. It has proven deficient, however, to rely merely on such frictional forces for proper retention of the seal component 14. In typical shaft seal applications, particularly utilizing plastic application housings, the housing structures may have extreme dimensional tolerances, which results in there being a significant variation in bore diameters of the housing structure (such as the housing structure 12 of FIG. 1). An effective seal component, therefore, must be effective across such tolerances of varying range of bore diameters. Accordingly, seals that rely on frictional forces alone have often been deficient in maintaining an adequate seal.

FIG. 2 is a schematic diagram depicting a perspective view of a portion of another conventional shaft seal assembly 30 that is a variation of the shaft seal assembly 10 of FIG. 1. Like structures are labeled comparably in FIG. 2 as in FIG. 1. The seal assembly 30 of FIG. 2 is configured to enhance the retention of the seal component 14 as compared to the configuration in FIG. 1. Specifically, in the seal assembly 30 the housing structure 12 further includes an undercut 32 further machined into the housing structure 12 adjacent the bore 16. In addition, the seal component 14, in addition to the rib structures 26, further includes an extended rib 34 that is inserted into the undercut 32.

By providing the undercut 32 that receives the extended rib 34, enhanced retention is achieved. However, there are significant drawbacks to such configuration. The machining process for adding the undercut 32 adjacent the bore 16 is a delicate operation that adds significant effort and expense to the manufacture of the housing structure. Particularly for plastic housings and in relation to typical shaft seal applications, simple molding of the undercut generally is not an option to the configuration of the undercut, and thus the referenced machining must be performed precisely as to each housing structure. Accordingly, although the configuration of FIG. 2 may enhance seal retention, the configuration remains an undesirable solution due to the added complexity of manufacture.

### SUMMARY OF THE INVENTION

The present invention provides improved retention of shaft seal components and assemblies for use in applications involving high rotational forces, and extremes of temperature and pressure. The shaft seal components and assemblies of the present invention provide improved seal retention without requiring complex machining of undercuts in the housing structure as compared to conventional configurations, while maintaining an effective seal in the associated applications.

Accordingly, an aspect of the invention is a shaft seal assembly including a seal component with a bore retention feature. In an exemplary embodiment, the seal component includes a hook retention feature including a hook element that hooks around a ridge that partially defines the bore of the housing structure. In this manner, the hook element provides for enhanced seal retention, but does not require the additional machining of an undercut into the bore area of the housing structure.

Another aspect of the invention is a seal component for a shaft seal assembly. Embodiments of the seal component include an elastomeric element that has a hook retention feature configured to receive a portion of a housing structure of the shaft seal assembly, wherein the hook retention feature provides a gripping force to retain the seal component adjacent the housing structure. Another aspect of the invention is a shaft seal assembly. Embodiments of the shaft seal assembly include the described seal component including the hook retention feature, and a housing structure, wherein a portion of the housing structure is received in the hook retention feature of the seal component.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF DRAWINGS

FIG. 1 is a schematic diagram depicting a perspective view of a portion of a conventional shaft seal assembly.

FIG. 2 is a schematic diagram depicting a perspective view of a portion of another conventional shaft seal assembly that is a variation of the shaft seal assembly of FIG. 1.

FIG. 3 is a schematic diagram depicting a perspective view of a portion of a shaft seal assembly containing a hook retention feature in accordance with embodiments of the present invention.

### DETAILED DESCRIPTION

Embodiments of the present invention will now be described with reference to the drawings, wherein like reference numerals are used to refer to like elements throughout. It will be understood that the figures are not necessarily to scale.

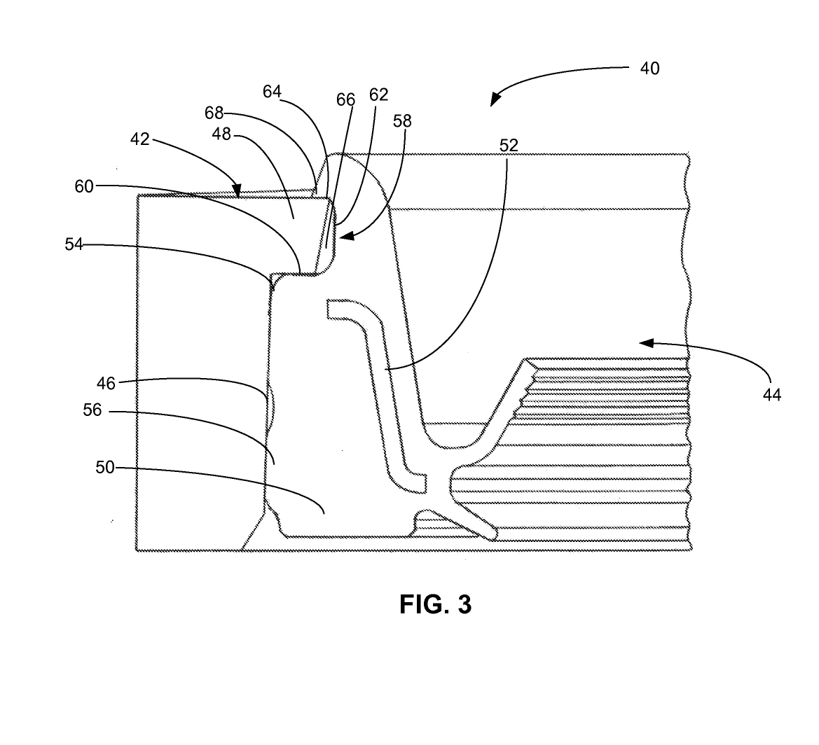

FIG. 3 is a schematic diagram depicting a perspective view of a portion of a shaft seal assembly 40 containing a hook retention feature in accordance with embodiments of the present invention. The shaft seal assembly may extend circumferentially substantially to form a ring structure such as may be employed, for example, in a front crank shaft seal and like applications as referenced above. The shaft seal includes a housing structure 42 against which is inserted a seal component 44. The housing structure 42 typically is made of a rigid or semi-rigid material, such as a rigid or semi-rigid molded plastic or metal material such as steel. Plastic housing structures are well known in the art and in particular have become common in the automotive and light-truck industries for certain engine assembly shaft seals. The housing structure defines a bore 46 that constitutes a recessed area or surface in or against which the seal component 44 rests. In the example of FIG. 3, the bore 46 is defined partially by a ridge 48 that extends from a main body of the housing structure and aids in holding the seal within the bore as further explained below.

As referenced above, the shaft seal assembly 40 further includes the seal component 44. The seal component 44 of FIG. 3 includes an elastomeric element 50 formed about a substrate 52. The substrate 52 thus is embedded within the elastomeric element 50. The elastomeric element generally provides flexibility to the seal so the seal may be compressed and energized to form a tight seal within the shaft or bore of the housing structure. The elastomeric element 50 may be made of any of a variety of suitable flexible, rubber-like materials. Suitable materials include, for example, various fluoro-elastomers, poly-acrylic materials, ethylene-acrylic materials, and like materials that are suitable to withstand the exposure to high pressures and extreme temperatures of typical applications. The substrate 52 is formed of a more rigid material, such as a rigid or semi-rigid plastic or metal (steel for example), that acts as a stiffener element for controlling in part the degree of compressibility of the surrounding elastomeric element 50.

The seal component 44 has an outer diameter 54 onto which there are formed a plurality of rib structures 56. The seal component 44 is held in place within or adjacent the bore 46 in part by the frictional forces of the rib structures 56 against an inner diameter surface of the bore 46 of the housing structure. In addition, the seal component 44 further includes a hook retention feature 58 that provides enhanced retention of the seal component 44 within the housing structure 42. In particular, the hook retention feature is configured to receive a portion of the housing structure of the shaft seal assembly, wherein the hook retention feature provides a gripping force to retain the seal component adjacent the housing structure.

The hook retention feature 58 is configured in this example as follows. The hook retention feature 58 includes a first surface 60, a second surface 62, and a third surface 64 that collectively define a retention recess 66 that receives a portion of the housing structure, such as the ridge 48 portion of the housing structure. In this embodiment, the third surface 64 also is a bottom surface of a hook 68. In an assembled configuration, the retention recess 66 of the seal component 44 receives the ridge 48 portion of the housing structure 42. In addition, a hook 68 extends around the ridge 48 portion of the housing structure such that the third surface 64 rests at least in part on top of the ridge 48. When the seal component 44 is compressed and energized to achieve a tight fit within the housing structure 42, a gripping force exerted by the hook 68 provides a gripping force to the ridge 48 within the retention recess 66. In this manner, the hook retention feature 58 provides for enhanced retention of the seal component 44 within the housing structure 42, without the need of machining an additional undercut, as compared to conventional configurations.

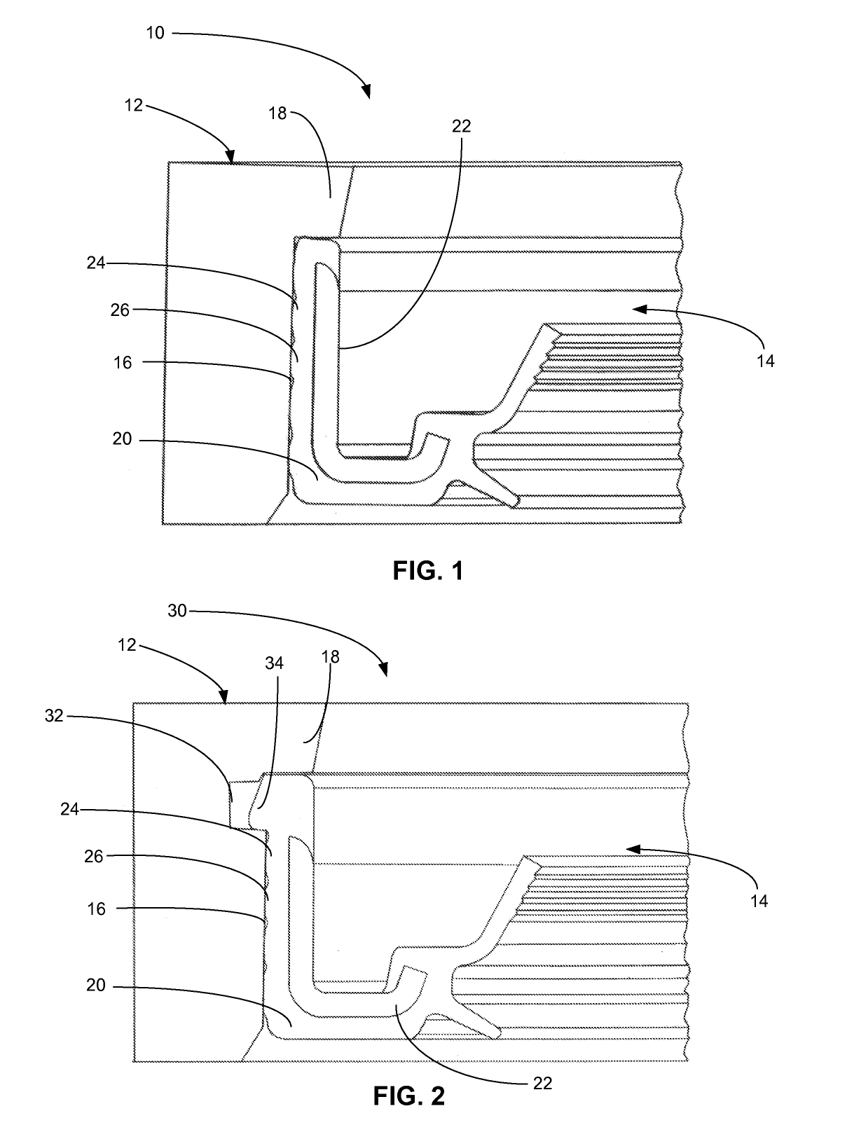

Comparing the embodiment of FIG. 3 to the conventional configurations of FIGS. 1 and 2, the embodiment of FIG. 3 includes fewer rib structures. In the example of FIG. 3, only two rib structures 56 are included with significantly larger contours than is conventional, although the precise number may be varied. In addition, the dimensions of the substrate 52 are smaller than in the conventional configuration. This results in the seal component 44 having an increased volume of compressible material as compared to the conventional configurations. This added compressibility requires fewer rib structures for retaining the seal component within the bore, and also aids in the gripping action of the hook retention feature 58 of the ridge 48.

In accordance with the above features, an aspect of the invention is a seal component for a shaft seal assembly. In an exemplary embodiment, the seal component includes an elastomeric element that has a hook retention feature configured to receive a portion of a housing structure of the shaft seal assembly, wherein the hook retention feature provides a gripping force to retain the seal component adjacent the housing structure.

In another exemplary embodiment of the seal component, the hook retention feature includes a first surface, a second surface, and a third surface that define a recess that receives the portion of the housing structure.

In another exemplary embodiment of the seal component, the third surface is a bottom surface of a hook that extends around the received portion of the housing structure.

In another exemplary embodiment of the seal component, the seal component has an outer diameter that includes a plurality of rib structures, wherein the rib structures provide a frictional force against a bore defined by the housing structure.

In another exemplary embodiment of the seal component, the seal component further includes a substrate embedded within the elastomeric element.

Another aspect of the invention is a shaft seal assembly. In an exemplary embodiment, the shaft seal assembly includes the described seal component with the hook retention feature and a housing structure, wherein a portion of the housing structure is received in the hook retention feature of the seal component.

In another exemplary embodiment of the shaft seal assembly, the housing structure defines a bore that is partially defined by a ridge, and the ridge is the portion of the housing structure that is received in the hook retention feature of the seal component.

In another exemplary embodiment of the shaft seal assembly, the hook retention feature includes a first surface, a second surface, and a third surface that define a recess that receives the portion of the housing structure.

In another exemplary embodiment of the shaft seal assembly, the third surface is a bottom surface of a hook that extends around the received portion of the housing structure.

In another exemplary embodiment of the shaft seal assembly, the seal component has an outer diameter that includes a plurality of rib structures, wherein the rib structures provide a frictional force against a bore defined by the housing structure.

In another exemplary embodiment of the shaft seal assembly, the seal component further includes a substrate embedded within the elastomeric element.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A seal component for a shaft seal assembly comprising:
an elastomeric element that has a hook retention feature configured to receive a portion of a housing structure of the shaft seal assembly, wherein the hook retention feature provides a gripping force to retain the seal component adjacent the housing structure.

2. The seal component of claim 1, wherein the hook retention feature comprises a first surface, a second surface, and a third surface that define a recess that receives the portion of the housing structure.

3. The seal component of claim 2, wherein the third surface is a bottom surface of a hook that extends around the received portion of the housing structure.

4. The seal component of claim 1, wherein the seal component has an outer diameter that includes a plurality of rib structures, wherein the rib structures provide a frictional force against a bore defined by the housing structure.

5. The seal component of claim 1, further comprising a substrate embedded within the elastomeric element.

6. A shaft seal assembly comprising:
a housing structure; and
a seal component comprising an elastomeric element that has a hook retention feature configured to receive a portion of the housing structure of the shaft seal assembly, wherein the hook retention feature provides a gripping force to retain the seal component adjacent the housing structure.

7. The shaft assembly of claim 6, wherein the housing structure defines a bore that is partially defined by a ridge, and the ridge is the portion of the housing structure that is received in the hook retention feature of the seal component.

8. The shaft assembly of claim 6, wherein the hook retention feature comprises a first surface, a second surface, and a third surface that define a recess that receives the portion of the housing structure.

9. The shaft assembly of claim 8, wherein the third surface is a bottom surface of a hook that extends around the received portion of the housing structure.

10. The shaft assembly of claim 6, wherein the seal component has an outer diameter that includes a plurality of rib structures, wherein the rib structures provide a frictional force against a bore defined by the housing structure.

11. The shaft assembly of claim 6, wherein the seal component further comprises a substrate embedded within the elastomeric element.
